(19) United States
(12) Patent Application Publication
(10) Pub. No.: US 2002/0033424 A1
(43) Pub. Date: Mar. 21, 2002

(54) Shower apparatus

(76) Inventors: Santagio Rivera, San Diego, CA (US); Ruben H. Lujan, San Diego, CA (US)

Correspondence Address: James A. LaBarre, Esquire, BURNS, DOANE, SWECKER & MATHIS, L.L.P., P.O. Box 1404, Alexandria, VA, 22313-1404, US

(21) Appl. No.: 09/912,560

(22) Filed: Jul. 26, 2001

Related U.S. Application Data
(60) Provisional application No. 60/233,932, filed on Sep. 20, 2000.

(51) Int. Cl. A62C 5/02

(52) U.S. Cl. 239/310; 239/329; 239/333; 239/412

(57) ABSTRACT

The invention describes a shower and a faucet apparatus which includes a showerhead (or faucet) and a feeding mechanism, the showerhead (or faucet) includes a water inlet, a water outlet and a water passageway connecting said water inlet and outlet. A feeding aperture is provided on the showerhead (or faucet) connected to the feeding mechanism and the feeding mechanism includes a pump to deliver a substance through the feeding aperture into the passageway for subsequent dispensing through the water outlet. This invention provides a very user friendly water and substances dispensing system particularly useful for the public in the enjoyment of a shower.

### CROSS-REFERENCE TO RELATED APPLICATIONS

This application claims the benefit of the filing date of U.S. Provisional Patent Application No. 477,658, filed Aug. 2, 2000.

### FIELD OF THE INVENTION

The present invention relates to a shower apparatus and, more particularly, to a shower apparatus which is provided with means to deliver preferred substances, for example, shampoo, shower gel, essential oil, fragrance, or other suitable body cleansing or nourishing substance, into the main water passageway of a showerhead of the shower apparatus or a faucet before the water leaves the showerhead outlet or faucet. More specifically, although not necessarily solely limiting thereto, the present invention relates to a wall mountable shower apparatus assembly on which there are mounted a showerhead as well as means for delivering one or more preferred substances into the main water passageway of the showerhead. The present invention also relates generally to other water fixtures such as faucets, faucet assemblies or other water dispensing systems.

### BACKGROUND OF THE INVENTION

Shower facilities are extensively used for body cleansing and refreshing at homes, sports clubs, swimming pools or other public establishments. A shower, as compared to a bath, is generally preferred in public establishments because it is generally more hygienic and provides instantaneous cleansing as soon as the showerhead is turned on since there is no need to wait for a bath tub to be filled up with water before a person can start bathing. Also, showering in general requires less water and is therefore more environmental friendly and desirable for water conservation and the energy required to heat water.

On the other hand, bathing in a bath tub or basin is generally considered to be more relaxing and enjoyable because a person can add preferred substances, for example, bath oil, essential oil, mineral salt, fragrance, or other suitable body cleansing, toning or nourishing substances into the water before or anytime during a bath. However, because of the fast running nature of water in a shower system, it is uneconomical and environmentally unfriendly to provide a continuous supply of running water which has been pre-mixed with the preferred substances. Also, as there can be various types of preferred substances, such as, shower gel, hair conditioner, shampoo, essential oil or body conditioner, which are not suitable for mixing or which an individual user may choose during a shower, a centralized or pre-mixed supply of a mixture of water and preferred substances is unlikely to be able to cater for the personal preferences or needs of all individuals.

Hence, it would be desirable if there can be provided a shower apparatus which is adapted to supply preferred substances to a running supply of water and to which the preferred substances are provided as and when desired by the individual. The shower apparatus preferably has means to enable a user to select one or more types of preferred substances to be mixed with the water. Furthermore, it will be desirable if the type and amount of preferred substances to be added into the running water can be conveniently selected and the volume easily adjusted according to the personal preference of the individual users.

The above desirable objectives are long existing and various proposals have been made to achieve them. For example, in U.S. Pat. No. 2,625, 430, there is described a showerhead fixture having a reservoir of preferred substances which is placed above the showerhead. Delivery of the preferred substances is by means of an impeller which rotates a rotary-valve to drip the preferred substance into the water-stream. The mixing action is activated by swinging the impeller down into the path of the water-stream and is stopped by swinging the impeller away from the water-stream.

U.S. Pat. No. 3,409,230 describes an apparatus having a reservoir of preferred substances and a pair of bifurcated-legs which straddle the showerhead and header-pipe, thereby positioning the nose of the reservoir into the water-stream so as to create a siphon mixing action.

U.S. Pat. No. 3,623,638 describes an apparatus having a reservoir of preferred substances which is mounted upon the wall adjoining the showerhead. A flexible conduit is positioned to discharge preferred substances immediately above the water-stream and the preferred substances are fed into the water stream by gravity on opening of a valve.

In U.S. Pat. No. 3,801,018, there is described a showerhead having a built-in water-spun device which serves to mix a preferred substance. The preferred substance is supplied from a gravity-feed reservoir supported upon a feeder-conduit placed immediately above the showerhead.

In U.S. Pat. No. 4,211,368, there is described an aerator device which serves to draw in ambient air and actively mix the air and water, thereby giving the water-stream a softer feel to the user.

In U.S. Pat. No. 4,219,158, there is described a special showerhead and header-pipe combination with a reservoir of preferred substances built-in to the header-pipe portion so as to feed (via siphon action) the preferred substances via an internal conduit into the showerhead immediately behind the outlet-face portion of the showerhead.

In U.S. Pat. No. 4,921,171, there is described a reservoir of preferred substances which is provided with a pull-knob actuated piston-pump above the showerhead portion. Pulling of the knob allows liquid-product to gravity-flow into the impinging water-stream.

In U.S. Pat. No. 4,998,836, there is described a hand-held showerhead which is connected to a wall-mounted liquid-product reservoir via a flexible water-conduit. The flow of preferred substances by siphon action is controlled by manually rotating an annular control-ring provided on the showerhead which adjusts the water flow by the change in siphon flow.

In U.S. Pat. No. 5,114,048, there is described a faucet assembly having a discrete pair of built-in manual dispensing pumps which supply preferred substances to a user via discrete built-in conduits. In this system, the preferred substances are not mixed with the running water.

In U.S. Pat. No. 5,135,173, there is described a showerhead apparatus in which two types of preferred substances can be introduced into a mixer-valve housing via two discrete conduits. However, because of the delay in siphon mixing which takes place within the showerhead, the two types of preferred substances may be undesirably mixed within the mixer housing.

In U.S. Pat. No. 5,823,441, there is described an intermediate adapted-mixer unit for a showerhead which draws the preferred substances into the mixer by a central-venturi or a lateral siphon-duct.

In U.S. Pat. No. 5,915,622, there is described a mixing-container device which is installed between the existing header-pipe and showerhead members, the mixing-container includes an inlet-port which diverts a portion of the water to flow within the container and collect bathing-additives prior to being suctioned back into the water-flow for dispensing through.

In U.S. Pat. No. 6,045,060, there is described a liquid-product mixer-valve for showerheads, in which an intermediate Y-shaped adapter enabling the user to install a gravity-feed type of reservoir between the existing header-pipe and existing showerhead members is provided.

Other known proposed apparatus and systems include those described in U.S. Pat. Nos. 2,705,091, 3,079,093, 3,198,437, 3,813,072, 3,907,203, 3,990,611, 4,068,681, 4,121,773, 4,131,232, 4,219,159, 4,625,896, 5,031,258, 5,114,049, U.S. Pat. No. D-331,794, U.S. Pat. No. 5,452,825, U.S. Pat. No. D-324,619, U.S. Pat. Nos. 5,562,248, 5,842,645, 5,857,594.

Upon a review of the above, it will be apparent that most of the known proposals described above which are generally adapted to achieve the afore-said objectives are either based on suction, siphon action or venturi delivery of the preferred substances. In general, such systems are known to be unreliable because the delivery of the preferred substances is largely dependent on the main water flow and is not generally adjustable by the individual users as and when they wish. In addition, fluid delivery systems operated by suction, siphon or venturi are generally slow, easily clogged, and the delivery is relatively un-controllable and with undesirable delay. Suction systems are particularly unsuitable where different types of preferred substances need to be alternatively or sequentially dispensed and should not be mixed.

Furthermore, since most of the afore-said known or proposed devices or systems are operated by gravity or suction, a reservoir of preferred substances is usually placed above the showerhead when in actual use. Such systems do not have much practical values as it will be extremely difficult and uncomfortable for an individual to reach the reservoirs or the controlling valves to adjust the dispensing of the preferred substances, especially after strenuous exercises and more particularly when the height of individuals vary.

In conventional shower rooms, discrete bottles of preferred substances are usually placed side by side on shelves or compartments for the choice and use of the individual users. However, a significant portion of preferred substances is always lost during transit from the container to the user in the shower because of flushing by the running water coming out of the showerhead. Also, in shower rooms of the more prestigious establishments, the laying around of a number of bottles of different designs of preferred substances side by side is somewhat unsightly and not compatible to the aesthetic expectation of patrons of such establishments.

In addition, stealing of preferred substances from public establishments, especially in high-class establishments in which containers of unique design and quality are provided, is always a problem and can be annoying to other users. Some establishments attempt to solve this problem by chaining the individual bottles. However, this approach is certainly not preferred for the more prestigious establishments and may attract harsh criticism. Hence, it would be desirable if a shower apparatus which alleviates all, or a combination of, the above shortcomings or problems associated with the set-up of conventional showers or shower rooms can be provided.

### OBJECT OF THE INVENTION

Accordingly, it is an object of the present invention to provide a shower apparatus which can be comfortably and conveniently used by an individual and which can provide mixing of running water with preferred substances for showering in which the delivery and supply of the preferred substances can be easily and readily controlled by the user. Such a shower apparatus is preferably provided with means of dispensing a variety of preferred substances into the running water upon the selection of a user so that the user can select one or a combination of the preferred substances of his own choice. It is also an object of the present invention to provide an integrated shower apparatus so that the preferred substances as well as their dispensing means can be stored in a housing which can be aesthetically and ergonomically designed.

It is a further object of the present invention to provide a shower apparatus which at least partly fulfils the above expectations of the public while also alleviating the aesthetic and security problems associated with the set up of a conventional shower room mentioned above.

### SUMMARY OF THE INVENTION

According to a first aspect of the present invention, there is provided a shower apparatus including a showerhead and a feeding mechanism, said showerhead includes a water inlet, a water outlet and a water passageway connecting said water inlet and outlet, wherein a feeding aperture is provided on said showerhead connected to said feeding mechanism and said feeding mechanism includes a pump to deliver a substance through said feeding aperture into said passageway for subsequent dispensing through said water outlet.

Preferably, the feeding mechanism includes a plurality of feeding apertures which are formed on said showerhead so that a plurality of preferred substances can be selectively delivered into said water passageway by pumping upon actuation by a user.

Preferably, the pump is a manually actuated pump and is a hand-actuated pump acting against a spring bias.

Preferably, the pump includes a first and a second alternate outlets which are adapted to respectively deliver said preferred substance to said showerhead or the user directly.

Preferably, the pump includes an actuation means which is located below said showerhead after said apparatus has been wall mounted.

Preferably, both showerhead and said feeding mechanism are mounted on a solid wall-mountable housing.

Preferably, the wall-mountable housing includes a receptacle for storing said preferred substances.

Preferably, the housing includes further receptacles for storing other substances.

Preferably, the feeding aperture and said pump are connected by an upwardly extending conduit.

Preferably, the pump includes a fluid compartment having a first and a second alternately opening one-way valve.

According to a second aspect of the present invention, there is provided a water dispensing apparatus including a faucet and a feeding mechanism, said faucet includes a water inlet, a water outlet and a water passageway connecting said water inlet and outlet, wherein a feeding aperture is provided on said faucet connected to said feeding mechanism and said feeding mechanism includes a pump to deliver a substance through said feeding aperture into said passageway for subsequent dispensing through said water outlet.

Preferably, the feeding mechanism includes a plurality of feeding apertures which are formed on said faucet so that a plurality of preferred substances can be selectively delivered into said water passageway by pumping upon actuation by a user.

### BRIEF DESCRIPTION OF THE DRAWINGS

The present invention will now be explained by way of examples and with reference to the accompanying drawings in which:

FIG. 1A is a sketch showing a shower apparatus having a gravity or siphon feeding system for feeding preferred substances;

FIG. 1B is a sketch showing another type of prior art gravity-feed or discrete-bottle type apparatus in which a preferred substances is added to the stream of water after it has exited from the showerhead;

FIG. 2 is a schematic diagram showing a first embodiment of the present invention in which there is provided an arrangement of a showerhead and a feeding mechanism wherein the feeding mechanism is connected to the showerhead at a position between the water inlet and outlet;

FIG. 2A is a diagram illustrating a second embodiment of the present invention;

FIG. 2B is a schematic diagram illustrating a third embodiment of the showerhead of the present invention;

FIG. 2C is a diagram illustrating an alternative embodiment of the embodiment of FIG. 2B;

FIG. 3 is a diagram showing a fourth embodiment of the present invention;

FIG. 4A is a diagram showing the embodiment of FIG. 2B in combination with a conventional hair-saloon style trigger-nozzle;

FIG. 4B is a diagram illustrating the embodiment of FIG. 4A including a partially cutaway cross-section for better clarity;

FIG. 5 is a diagram showing a fifth embodiment of the present invention with a reservoir and a foot-operated pump unit;

FIG. 6 is a diagram showing an alternative embodiment of the present embodiment with a knee-actuated compressive pumping apparatus;

FIG. 7 is a top plan view of the showerhead of FIG. 2A;

FIG. 8 is a perspective view from below of the showerhead of FIG. 2B;

FIG. 9 illustrates the circuit connection from the manually actuated positive-pressure pump;

FIG. 10A is a front view of an example of a preferred embodiment of a compressive pump for use with the approach of FIG. 2;

FIG. 10B is a cross sectional view of the pump of FIG. 9A along the line A-A;

FIG. 10C is a bottom view of the pump of FIG. 9A with dotted lines showing a swivel outlet;

FIG. 11A is a schematic diagram showing the fluid chamber of the compressive pump being filled up with a preferred substance;

FIG. 11B illustrates the preferred substance stored in the fluid chamber in FIG. 11A being moved to a second chamber for dispensing through the outlet;

FIG. 12 is an exploded view showing the components of the compressive pump of FIG. 10A;

FIG. 13A shows in detail an example of the junction of the feeding conduits with the main water passageway; and

FIG. 13B shows the exploded view of the junction of FIG. 13A.

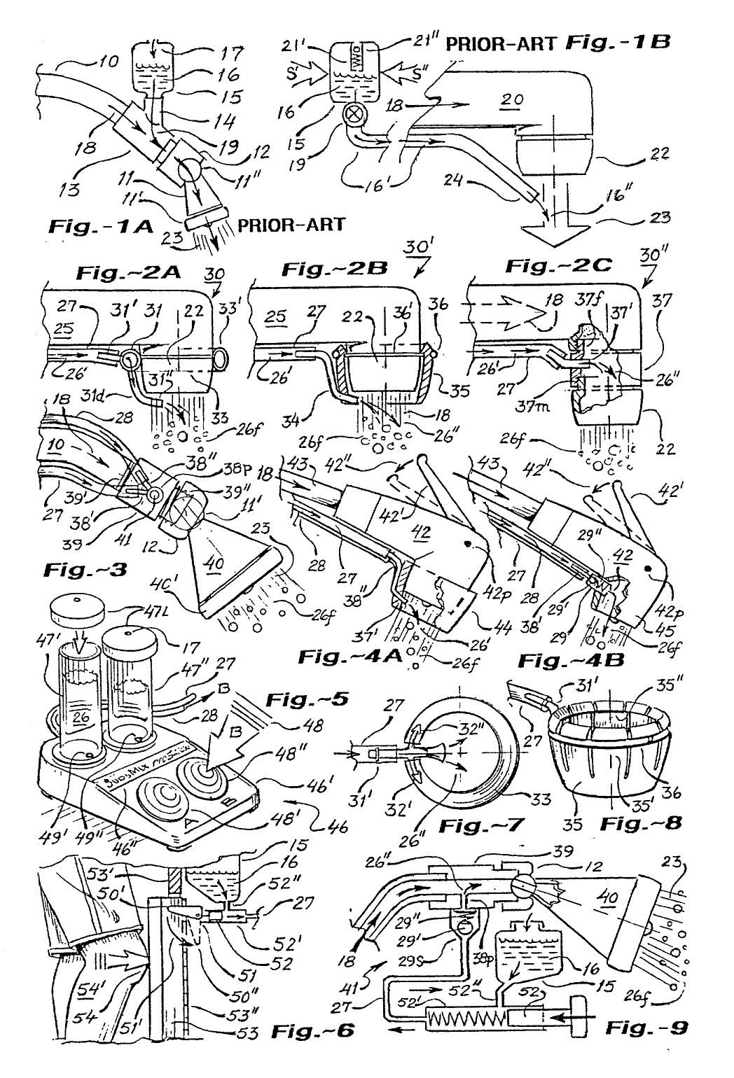

### DETAILED DESCRIPTION OF THE PREFERRED EMBODIMENTS

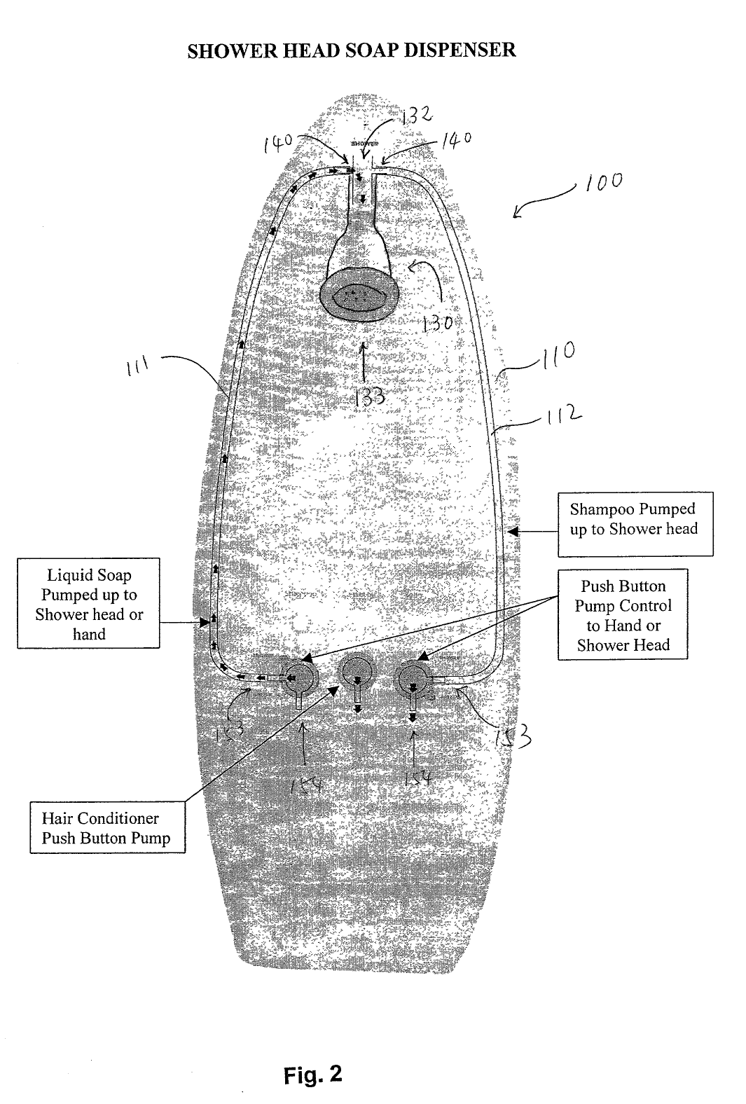

Referring to FIGS. 2 and 9, there is shown a shower apparatus (100) which includes a showerhead (130) and a feeding mechanism for additively feeding preferred substances into the water passageway (131) of the showerhead (130). The showerhead can, for example, be a conventional showerhead having a main water inlet (132) and a main water outlet (133) between which a water passageway (133) is defined. The outlet (133) of the showerhead preferably has a larger surface dimension than the inlet with an end plate on which there are distributed a plurality of apertures for forming a shower having a reasonable shower spread.

A feeding inlet (140) or aperture is preferably provided at a position intermediate between the water inlet (132) and outlet (133) of the showerhead. The feeding inlet (140) in the present embodiment includes an aperture abutting a nozzle member intersecting the water passageway (131) so that preferred substances can be fed into the water passageway from outside the showerhead.

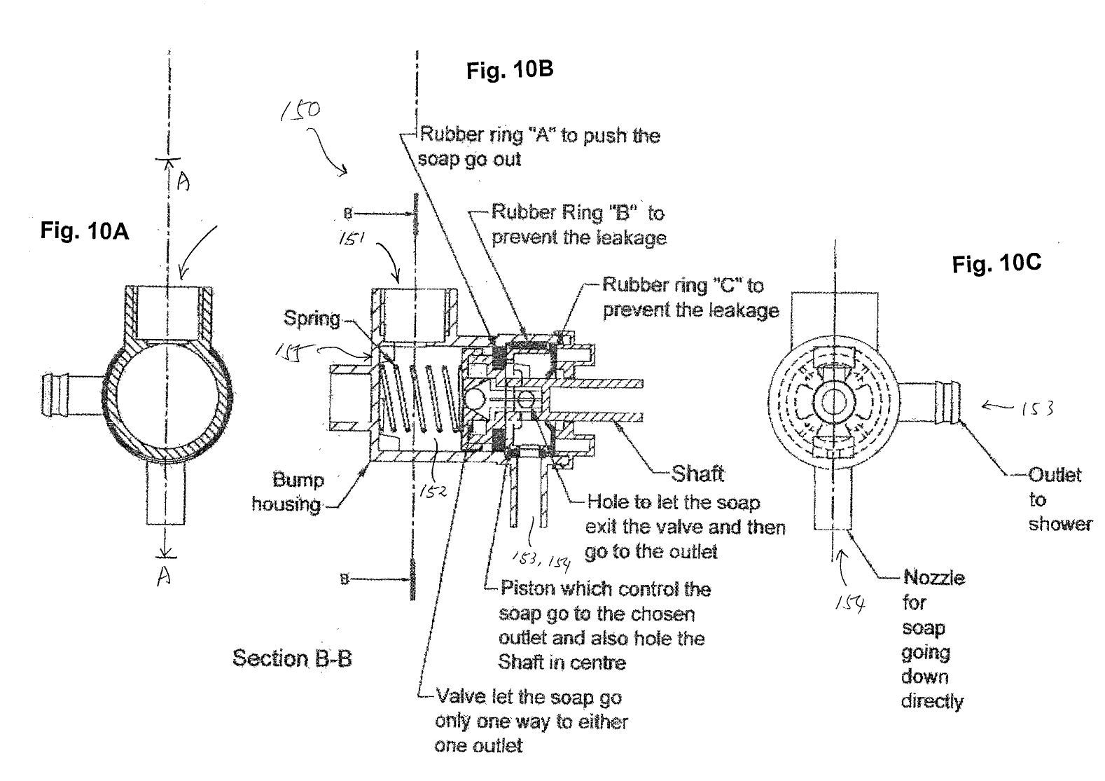

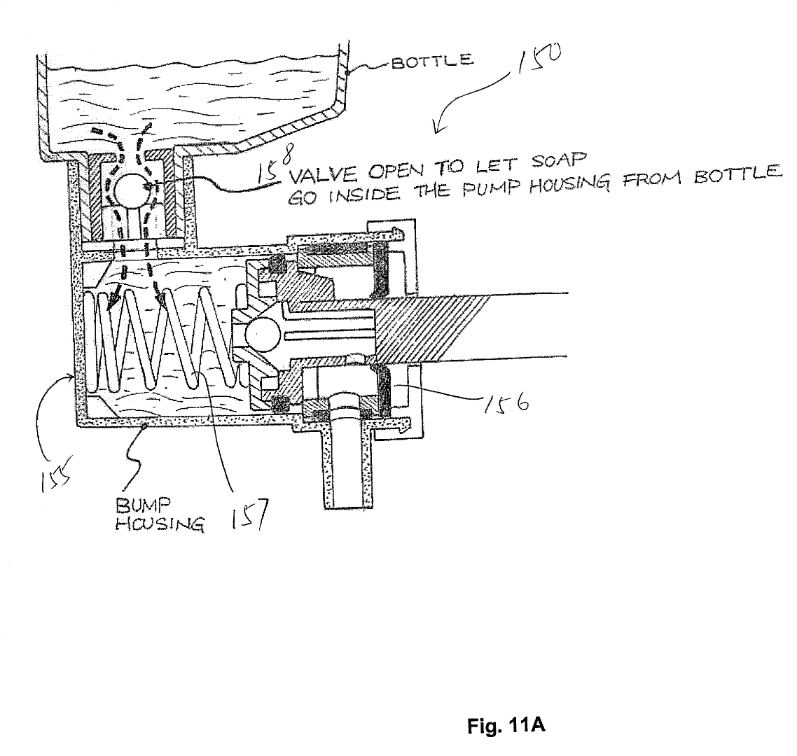

In order to feed preferred substances into the water passageway of the showerhead, a conduit (111, 112) which may be flexible or rigid is connected between the feeding inlet and a pump (150). The pump (150) is preferably a simple hand-actuated compressive pump as shown in FIGS. 10A to 10C, FIGS. 11A and 11B, and FIG. 12 or other types of simple pumping devices which are suitable for delivering fluid substances from a reservoir or container to the feeding inlet. A simple hand-actuated pump is preferred since the use of electrical energy in a bathroom may be dangerous. The hand pump is preferably provided with an additional alternative dispensing head so that a user may choose whether to mix the preferred substances, for example, shampoo, shower gel, hair conditioner, essential oil, with the water in the showerhead or to dispense the substances directly from the alternative dispensing head of the pump. The hand-actuated pump or its actuation means is preferably located well below the showerhead (130) and within easy reach of the hands of a user for easy and conformable usage.

Referring to FIGS. 10A-10C, there is shown an example of a suitable compressive pump (150) which may be used in the present apparatus. The compressive pump includes an inlet (151) for receiving the preferred fluid substances from a reservoir or container of the fluid substances, a fluid storage chamber (152) for temporary storing the fluid substances and a first (153) and a second (154) alternative outlets respectively for directing the preferred fluid substances to the showerhead or the direct dispenser. Initially, the fluid substance is filled inside the fluid storage chamber (152) which is provided for transit storage of the fluid substance. The user then delivers the fluid substance by compressively pressing the cap (155) of the fluid storage chamber to reduce the space inside the chamber, thereby forcing the fluid substance to exit from the storage chamber (152) and leaving through one of the two outlets (153, 154). The selected outlet is determined by a swivel (156) on which a fluid channel is formed so that the fluid substance only flows along the fluid channel to the selected outlet.

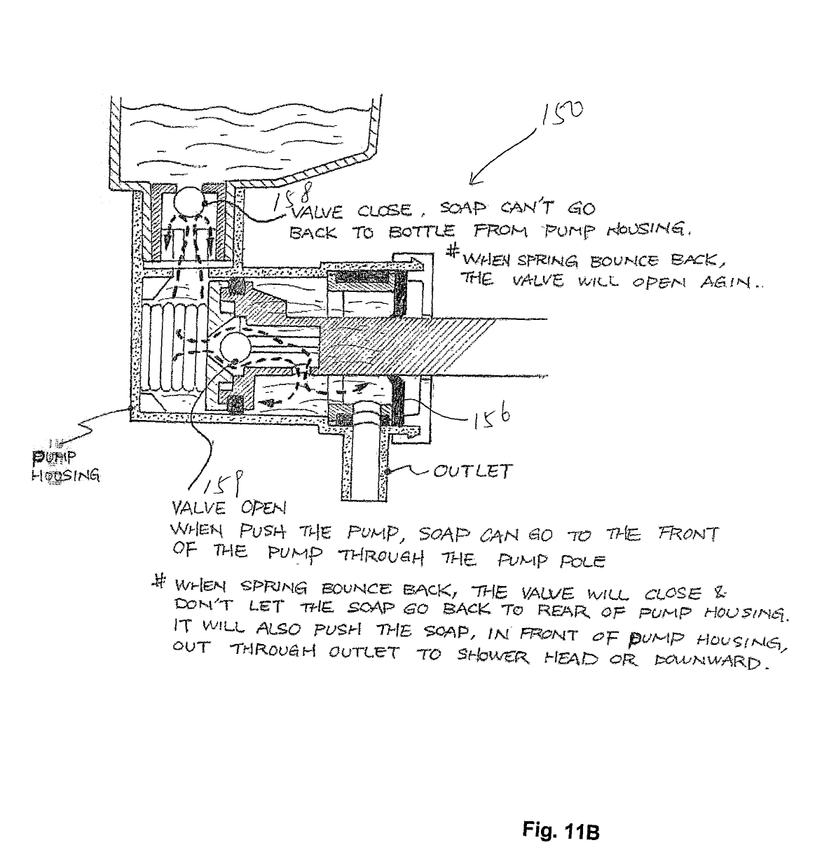

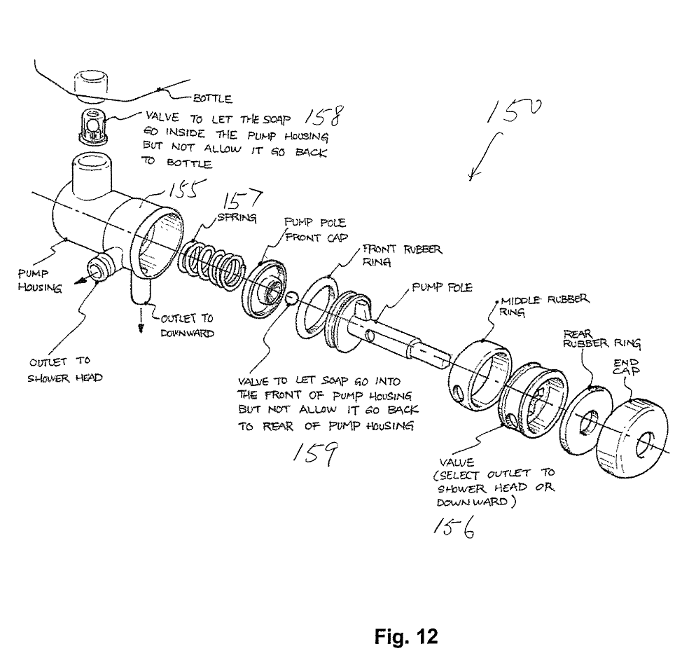

Turning to FIGS. 11A and 11B and with reference to FIG. 12, further operational details of the preferred compressive pump in use with the present embodiment are described. Referring firstly to FIG. 11A, the pump includes a first fluid compartment having a spring-biased variable storage space. A volume of preferred substance is firstly introduced, for example, by gravity feed or by suction, into the first fluid compartment. When the first fluid compartment expands from its fully compressed state by pressing the spring element (157) to its fully compressed state (as shown in FIG. 11B), the preferred substance will be drawn into this fluid compartment. An one-way valve (158), for example, a floating-ball type valve is provided to prevent reverse flow of the preferred substance into the reservoir of the preferred substance at the next compressive push. Referring now to FIG. 11B, the preferred substance-filled fluid chamber is compressively pressed to reduce the volume of the first fluid chamber. Such a press will force the stored preferred substance to move away from the fluid chamber and towards the fluid outlet as the reverse flow path is now blocked by the first one-way valve (158). At this time, the second one-way valve (159) is opened and the preferred substance will move into the selected outlet. By providing a swivel member having a defined fluid channel, a user can select the preferred outlet of the preferred substances, namely, either to add the preferred substance to the shower or to dispense directly from an outlet, by turning the swivel member and defining the outlet path with respect to the outlets. When the fluid storage chamber is expanded under action of the spring, the second one-way valve (159) will move to block the reverse flow of the preferred substance from the outlet path while the inlet path is opened through the release of the first one-way valve (158) for introducing the preferred substance.

The alternative dispensing heads or outlets may be formed with a swivel member (156) having a built-in fluid channel which a user may turn in order to select the desirable outlet to direct the exit of the preferred substances from the reservoir either to the conduit or to the alternate outlet. To provide more flexibility and sophistication, the feeding mechanism may include additional feeding apertures on the showerhead so that a user may selectively choose to feed the desirable preferred substances, or a combination thereof, to be mixed in the water passageway (131) before the water leaves the showerhead (130). In a specific preferred embodiment as shown in FIG. 2, the showerhead and the feeding mechanism are all mounted on a solid housing (110) which is preferably wall mountable so that the complete apparatus can be attached to the main water supply with a single connection and all the components of the apparatus are supported on the solid housing.

Preferably, receptacles for receiving other preferred fluid substances, for example, shampoo, hair conditioner, shower gel, essential oil or medicated substances are provided on the solid housing. Additional receptacles for storing other substances which may be dispensed directly from an outlet may also be provided within the housing. In this regard, a compressive pump may be installed on the solid housing for compressively delivering the preferred fluid substance directly to the user. By use of such an integrated shower apparatus, the shower facilities would be more aesthetically pleasing as more stylistic and ergonomic design can be incorporated into the housing design and the afore-said shortcomings are substantially alleviated by the use of the preferred feeding mechanism.

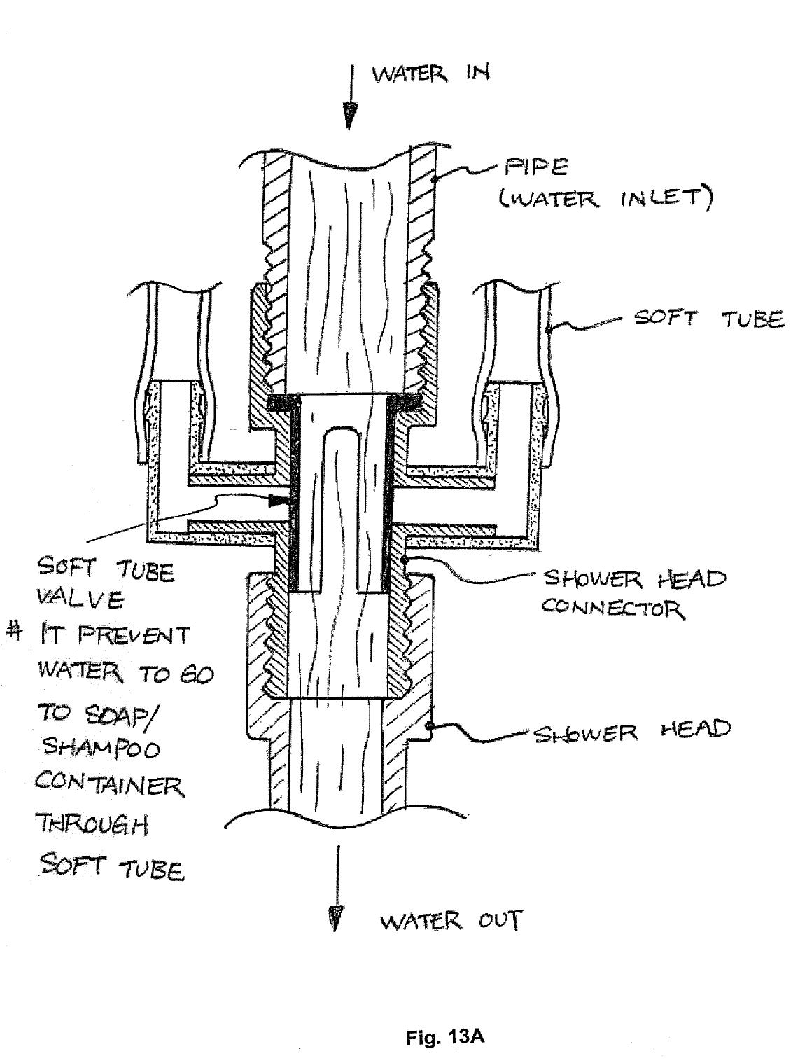

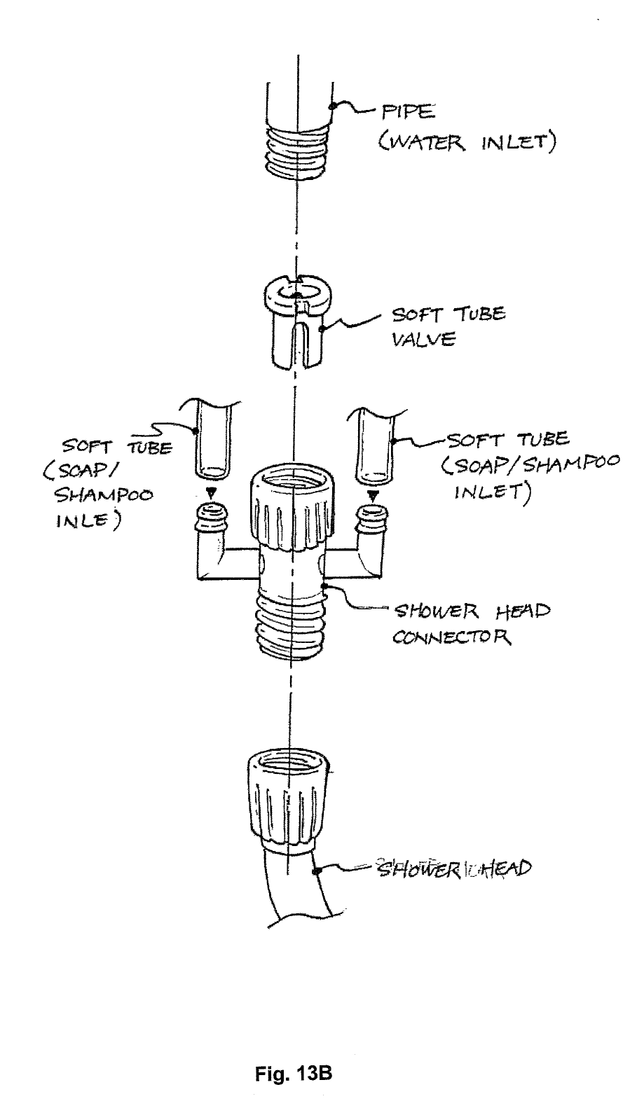

Referring to FIGS. 13A & B, there is shown in more detail an example of a preferred embodiment of a connection for feeding conduits into the main water passageway of a showerhead. The main passageway is provided with a first and a second tubular inlet for connecting to a first and a second preferred substance via a tubular adapter of a convenient shape, for example, L-shape. An one-way valve is provided so that there is a uni-directional flow of the preferred substances into the main water passageway and to prevent undesirable reverse flow of water from the main passageway into the feeding conduits. An example of a preferred one way valve which is suitable for use in the present invention is a soft tubular valve as shown in FIGS. 13A & B. The preferred soft rubber valve includes a first and a second flexible flap members which are placed adjacent to the junctions between the feeding conduits and the main water passageway. The flexible flap flexes away from the junction when preferred substances are being fed into the water passage way and prevents the water flowing in the main passage from leaking into the feeding conduits as the pressure of the water in the main passage way causes the flaps to close towards the junction, thereby forming a flexible unidirectional valve. Of course, other suitable one-way valves can also be used.

Referring to FIGS. 2A and 7, instead of feeding the preferred fluid substances into the water passageway, the preferred substances can be fed into the shower stream without mixing in the water passageway. In this way, the water inside the passageway is always clear of the preferred substances which may be preferable for some users.

Referring to FIGS. 2B, 2C and 8, there are shown second and third embodiments in which the preferred substances are fed into the showerhead very close to the water outlet so that there will be minimal mixing of the water and the preferred substances before being dispensed through the same outlet.

In FIG. 3, there is shown a further alternative to the shower arrangement of FIG. 2 in which conduits (27, 28) connecting to separate reservoirs of fluid containers are all merged at the same feeding aperture (38P) so that a single feeding aperture can be shared between a variety of preferred substances.

FIGS. 4A and 4B show alternative embodiments of the showerheads which may be used by persons skill in the art as alternatives. As further alternatives which may be used by persons skill in the art in the performance of the present invention, FIGS. 5 and 6 show further embodiments of the pumping devices which may be actuated respectively by the foot or by the knee.

While the present invention has been explained with reference to a showerhead, it will be obvious to persons skill in the art that the same invention and the specific embodiments can be modified without lost of generality to apply to faucets or faucet assemblies for use in kitchen in a similar manner.

Furthermore, while the present invention has been explained by reference to the specific embodiments and examples, it would be obvious to persons skill in the art that other possible embodiments may be derived or developed on the basis of the disclosed embodiments without lost of generality and without departing from the scope and spirit of the present invention as explained in the foregoing. More specifically, the scope of the present invention as defined in the claims hereto shall not be limited to the strict wording of the claims and should be liberally interpreted on the basis of the spirit of the teaching hereto.

1. A shower apparatus including a showerhead and a feeding mechanism, said showerhead includes a water inlet, a water outlet and a water passageway connecting said water inlet and outlet, wherein a feeding aperture is provided on said showerhead connected to said feeding mechanism and said feeding mechanism includes a pump to deliver a substance through said feeding aperture into said passageway for subsequent dispensing through said water outlet.

2. A shower apparatus according to claim 1, wherein said feeding mechanism includes a plurality of feeding apertures which are formed on said showerhead so that a plurality of preferred substances can be selectively delivered into said water passageway by pumping upon actuation by a user.

3. A shower apparatus according to claim 1, wherein said pump is a manually actuated pump.

4. A shower apparatus according to claim 1, wherein said pump is a hand-actuated pump acting against a spring bias.

5. A shower apparatus according to claim 1, wherein said pump includes a first and a second alternate outlets which are adapted to respectively deliver said preferred substance to said showerhead or the user directly.

6. A shower apparatus according to claim 1, wherein said pump includes an actuation means which is located below said showerhead after said apparatus has been wall mounted.

7. A shower apparatus according to claim 1, wherein both said showerhead and said feeding mechanism are mounted on a solid wall-mountable housing.

8. A shower apparatus according to claim 7, wherein said wall-mountable housing includes a receptacle for storing said preferred substances.

9. A shower apparatus according to claim 8, wherein said housing includes further receptacles for storing other substances.

10. A shower apparatus according to claim 1, wherein said feeding aperture and said pump are connected by an upwardly extending conduit.

11. A shower apparatus according to claim 1, wherein said pump includes a fluid compartment having a first and a second alternately opening one-way valve.

12. A shower apparatus according to claim 11, wherein said fluid compartment has a variable fluid storage space.

13. A shower apparatus according to claim 12, wherein the storage space of said fluid storage space is variable by a spring biased compartment.

14. A shower apparatus according to claim 12, further including a selectable outlet for diverting said stored substance to said showerhead or an alternative outlet.

15. A shower apparatus according to claim 13, whereinsaid selectable outlet includes a swivel member having a defined channel for selectively delivering said substance to selected outlet.

16. A shower apparatus according to claim 2, wherein a unidirectional flow valve is formed is formed at the junction between said feeding conduit and said water passageway of said showerhead.

17. A shower apparatus according to claim 16, wherein said unidirectional valve includes a flexible rubber flap.

18. A water dispensing apparatus including a faucet and a feeding mechanism, said faucet includes a water inlet, a water outlet and a water passageway connecting said water inlet and outlet, wherein a feeding aperture is provided on said faucet connected to said feeding mechanism and said feeding mechanism includes a pump to deliver a substance through said feeding aperture into said passageway for subsequent dispensing through said water outlet.

19. A water dispensing apparatus according to claim 18, wherein said feeding mechanism includes a plurality of feeding apertures which are formed on said faucet so that a plurality of preferred substances can be selectively delivered into said water passageway by pumping upon actuation by a user.

20. A water dispensing apparatus according to claim 18, wherein said pump is a manually actuated pump.

21. A water dispensing apparatus according to claim 18, wherein said pump is a hand-actuated pump acting against a spring bias.

22. A water dispensing apparatus according to claim 18, wherein said pump includes a first and a second alternate outlets which are adapted to respectively deliver said preferred substance to said faucet or the user directly.
